(19) United States
(12) Patent Application Publication
(10) Pub. No.: US 2026/0087491 A1
(43) Pub. Date: Mar. 26, 2026

(54) HIERARCHICAL DETERMINISTIC RECONCILIATION OF PROCEDURES ON DISTRIBUTED LEDGER NETWORK

(71) Applicant: SAP SE, Walldorf (DE)

(72) Inventors: Stefan ARNOLD, Leimen (DE); Brit PANZER, Mannheim (DE); Bernhard SCHWEIZER, Nussloch (DE)

(21) Appl. No.: 18/891,179

(22) Filed: Sep. 20, 2024

(51) Int. Cl. G06Q 20/38; G06Q 20/06

(52) U.S. Cl. CPC G06Q 20/3829; G06Q 20/065; G06Q 2220/00

(57) ABSTRACT

A procedure and address data store contains electronic records, and each master data record contains a pre-shared master address for a procedure originator. A procedure responder verifies a pre-shared master address associated with an originator. The master address is the root node of the destination addresses in a hierarchical tree of destination addresses. Each child address is derived from a parent address using a record identifier (e.g., an invoice or payment reference) and a cryptographic key derivation algorithm. The responder receives, from the originator, a procedure record including a record identifier associated with a procedure. The responder then predicts the destination address based on the pre-shared master address associated with the originator, the record identifier, and the algorithm. It is then arranged for the responder to complete the procedure with the originator via the predicted destination address, and information about the completed procedure is stored in a distributed ledger.

### BACKGROUND

An enterprise may enter into procedures or transactions with other parties. For example, a buyer might purchase goods or services from a seller or supplier. The seller may then send an invoice to the buyer who can arrange to make a payment to the seller, completing the procedure. The reconciliation of incoming payments poses significant challenges for businesses, particularly when supplementary information (such as invoice numbers or payment references) cannot be efficiently transmitted via the chosen payment rail. On traditional banking rails, this information is transmitted alongside the bank transfer. However, when dealing with payments that relate to multiple liabilities, the space available for such information is often insufficient to include all of the relevant details (such as multiple invoice numbers or payment references). Consequently, supplementary information may need to be submitted separately. Moreover, errors in the provided information by the sender may necessitate extensive manual follow-up processes or the adoption of costly add-on solutions for data cleansing, which are sometimes reliant on Artificial Intelligence (“AI”) or produce unpredictable results that need to be checked. Relying solely on payment amounts is inadequate for reconciliation, as payments may not consistently align with invoiced amounts due to various factors, such as batching or netting. “Batching” involves consolidating multiple procedures into a single payment, which can introduce discrepancies if not managed meticulously. “Netting” entails offsetting payables and receivables, influencing the final payment sum. Additionally, currency conversions, discounts, or misaligned adjustments can lead to further deviations. This intricacy poses a challenge for automated processes and necessitates comprehensive financial management to ensure precision and transparency.

In the context of distributed ledger technologies, such as blockchains or hashgraphs, procedures processed via these payment rails typically do not support freely usable fields for transmitting supplementary reference information at all.

It would therefore be desirable to provide procedure processing that helps invoice reconciliation and similar issues in a secure, automatic, and efficient manner.

### SUMMARY

According to some embodiments, methods and systems associated with procedure processing includes a master and procedure data store that contains electronic records (each record including a pre-shared master address for a procedure originator). A procedure responder verifies a pre-shared master address associated with a procedure originator (and the pre-shared master address is a root node of destination addresses in a hierarchical tree such that each child destination address of the hierarchical tree can be determined based on a parent destination address, a variable input such as a payment reference, and a cryptographic key derivation algorithm). The procedure responder receives, from the procedure originator, a procedure record including a record identifier associated with a procedure. The procedure responder then predicts the destination address based on the pre-shared master address associated with the procedure originator, the record identifier, and the cryptographic key derivation algorithm. It is then arranged for the procedure responder to complete the procedure with the procedure originator via the predicted destination address, and information about the completed procedure is stored in a secure, distributed ledger.

Some embodiments comprise: means for verifying, at a computer processor of a procedure processing framework by a procedure responder, a pre-shared master address associated with a procedure originator, wherein the pre-shared master address is a root node of destination addresses in a hierarchical tree such that each child destination address of the hierarchical tree can be determined based on a parent destination address, a variable input (such as a payment reference), and a cryptographic key derivation algorithm; means for receiving, by the procedure responder from the procedure originator, a procedure record including a record identifier associated with a procedure; means for predicting, by the procedure responder, a destination address based on the pre-shared master address associated with the procedure originator, the hierarchical tree, the record identifier, and the cryptographic key derivation algorithm; means for arranging for the procedure responder to complete the procedure with the procedure originator via the predicted destination address; and means for storing information about the completed procedure in a secure, distributed ledger.

Some technical advantages of some embodiments disclosed herein are improved systems and methods to provide procedure processing that helps invoice reconciliation and similar issues in a secure, automatic, and efficient manner.

According to some embodiments, by making the destination address predictable through a pre-shared master address, businesses can implement master data governance processes to verify the stable master address before initiating a payment – similar to existing procedures for traditional bank accounts. Businesses typically avoid making payments to a bank account number printed on an invoice or other payment request documents to prevent address forgery and other types of fraud. Therefore, printing rotating destination addresses on such documents would not be practical. The technical advantages of the disclosed embodiments allow businesses to print and share stable master addresses while predicting the actual one-time destination address based on a payment reference or invoice number in a secure and reliable manner. However, if business processes necessitate printing and sharing rotating destination addresses, business partners can verify that these addresses are derived from a trusted pre-shared root address associated with a specific procedure originator.

### BRIEF DESCRIPTION OF THE DRAWINGS

FIG. 1 is an example of invoice-based hierarchical deterministic wallets according to some embodiments.

FIG. 2 is a high-level procedure processing system architecture in accordance with some embodiments.

FIG. 3 is a procedure processing method according to some embodiments.

FIG. 4 is a tree of hierarchical wallets in accordance with some embodiments.

FIG. 5 is a procedure payee method according to some embodiments.

FIG. 6 is a procedure payer information flow in accordance with some embodiments.

FIG. 7 is a procedure payer information flow according to some embodiments.

FIG. 8 is a procedure payer method in accordance with some embodiments.

FIG. 9 is a more detailed procedure payer information flow according to some embodiments.

FIG. 10 is an invoice reconciliation method in accordance with some embodiments.

FIG. 11 is an apparatus or platform according to some embodiments.

FIG. 12 is a portion of a procedure database in accordance with some embodiments.

FIG. 13 illustrates a tablet computer according to some embodiments.

FIG. 14 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Some embodiments described herein leverage electronic wallets at the level of individual business documents, such as invoices, to enable reconciliation of payments with certainty – even in the absence of reference information. Each payment may be routed through a unique wallet address specifically created for that payment, ensuring precise reconciliation. Such an approach may help mitigate complexities associated with traditional reconciliation processes, such as batching, netting, currency conversions, etc., which can often lead to discrepancies and manual reconciliation efforts. However, the seller may need to message the “pay-to” destination wallet address to the buyer and could potentially be subject to address forgery during transmission. Thus, businesses may want to verify the pay-to destination wallet address independently as part of a master data governance process.

By utilizing Hierarchical Deterministic (“HD”) wallets, derived from a single root address through cryptographic key derivation algorithms, embodiments may facilitate the creation of a structured hierarchy of wallets. Adhering to established standards, such as Bitcoin Improvement Proposal protocol BIP32, may help ensure compatibility and efficiency across various applications. This deterministic approach enables businesses to pre-share and verify root addresses, mimicking traditional fiat-based methodologies and enhancing trust between business partners. Additionally, it can be verified that predicted “pay-to” destination wallet addresses are derived from a trusted root address, associated with a specific procedure originator.

Setting up a payment arrangement may involve agreement about the chosen distributed ledger network, digital currency, key derivation algorithm, and pre-shared root address (to ensure both parties can independently predict wallet addresses consistently). Additionally, robust procedures such as requiring two people to approve a procedure (the “Four-Eyes Principle”) and/or a separation of duties may be employed to help maintain compliance with regulatory standards and enhance security.

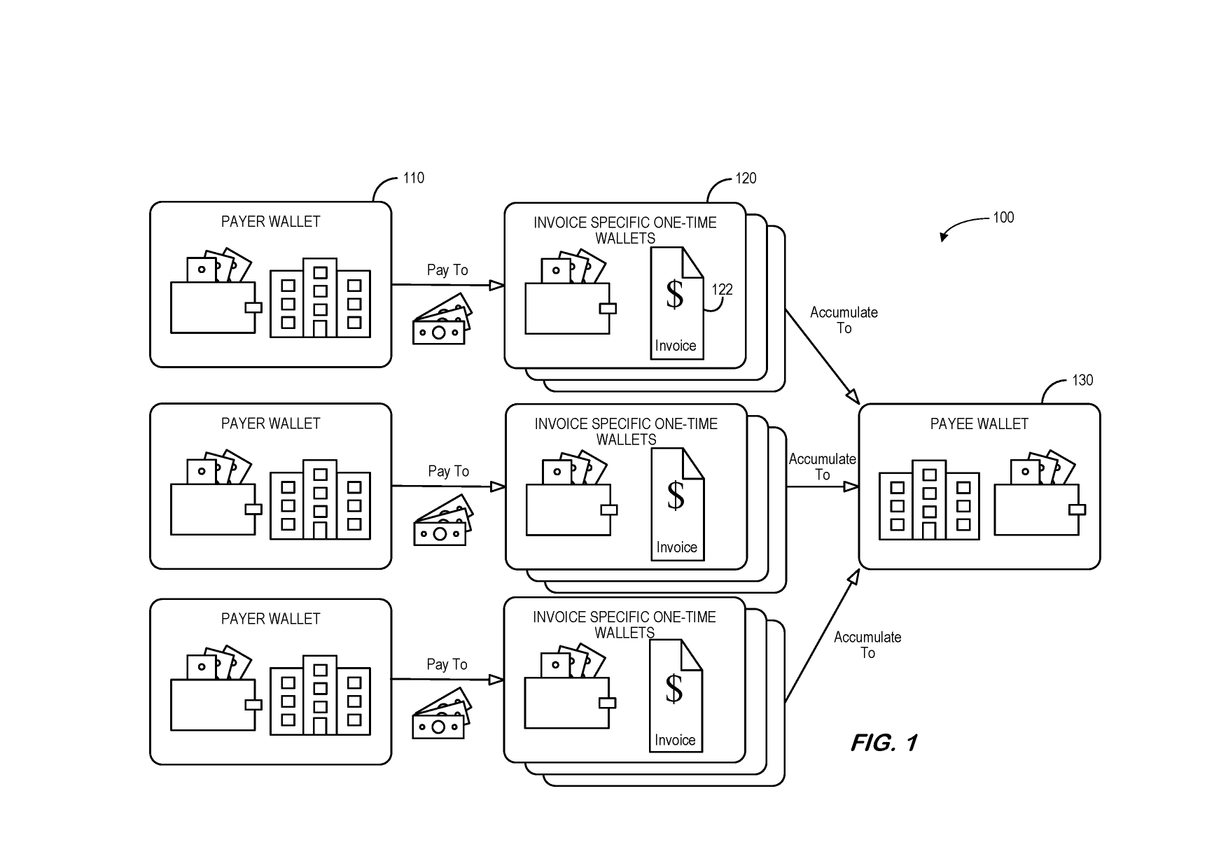

FIG. 1 is an example 100 of invoice-based hierarchical deterministic wallets according to some embodiments. Consider a seller who provides goods or services to a number of differ buyers. The buyers, as “payers,” may then provide payment to the seller, as “payee.” In this case, various payer wallets 110 may provide payments via invoice specific one-time wallets 120 that each have a unique destination address (based on an invoice number or payment reference and a pre-shared master address associated with the seller 122) that is specific to a particular procedure. Funds from all of the invoice specific one-time wallets 120 can then accumulate to a payee wallet 130. The payee uses the destination addresses to correctly reconcile payments among the payers.

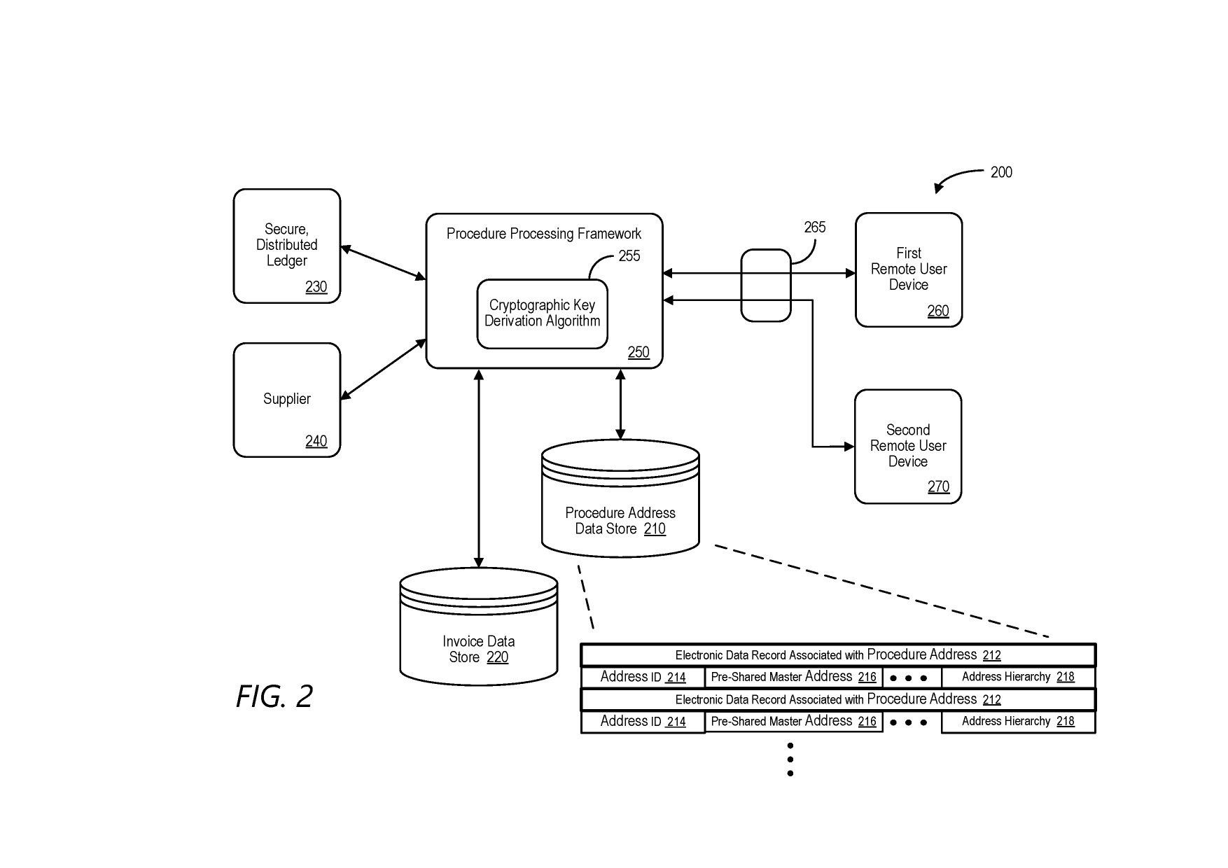

FIG. 2 is a high-level procedure processing system 200 architecture in accordance with some embodiments. In particular, the system 200 includes a procedure processing framework 250 that may access information in a procedure data store 210 (e.g., storing a set of electronic records associated with a procedure address 212, each record including, for example, one or more address identifiers 214, information about a pre-shared master address 216, address hierarchy information 218, etc.). The procedure processing framework 250 may also store information into other data stores, such as an invoice data store 220, and utilize a cryptographic key derivation algorithm 255 to exchange and process procedure payments and view, analyze, and/or update electronic records. The procedure processing framework 250 may also exchange information with a first remote user device 260 and a second remote user device 270 (e.g., via a firewall 265). According to some embodiments, an interactive Graphical User Interface (“GUI”) platform of the procedure processing framework 250 may facilitate the creation and review of procedure processing analysis, recommendations, alerts, and/or the display of results via one or more remote administrator computers (e.g., to summarize system 200 performance) and/or the remote user devices 260, 270. For example, the first remote user device 260 may transmit annotated and/or updated information to the procedure processing framework 250. Based on the updated information, the procedure processing framework 250 may adjust data in the procedure address data store 210 and/or the invoice data store 220 and the change may (or may not) be used in connection with the second remote user device 270. Note that the procedure processing framework 250 and/or any of the other devices and methods described herein might be associated with a third party, such as a vendor that performs a service for an enterprise. In some cases, an ingestion engine may exchange information associated with a secure, distributed ledger 230 and/or suppler devices 240.

The procedure processing framework 250 and/or the other elements of the system 200 might be, for example, associated with a Personal Computer (“PC”), laptop computer, smartphone, an enterprise server, a server farm, and/or a database or similar storage devices. According to some embodiments, an “automated” procedure processing framework 250 (and/or other elements of the system 200) may facilitate the automated access and/or update of electronic records in the data stores 210, 220 and/or the management of procedure processing. As used herein, the term “automated” may refer to, for example, actions that can be performed with little (or no) intervention by a human.

Devices, including those associated with the procedure processing framework 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The procedure processing framework 250 may store information into and/or retrieve information from the procedure address data store 210 and/or the invoice data store 220, which may be locally stored or reside remote from the procedure processing framework 250. As will be described further, the procedure address data store 210 may be used by the procedure processing framework 250 in connection with an interactive user interface to access and update electronic records. Although a single procedure processing framework 250 is shown in FIG. 2, any number of such devices may be included. Moreover, various devices described herein might be combined according to embodiments of the present invention. For example, in some embodiments, the procedure processing framework 250 and procedure address data store 210 might be co-located and/or may comprise a single apparatus.

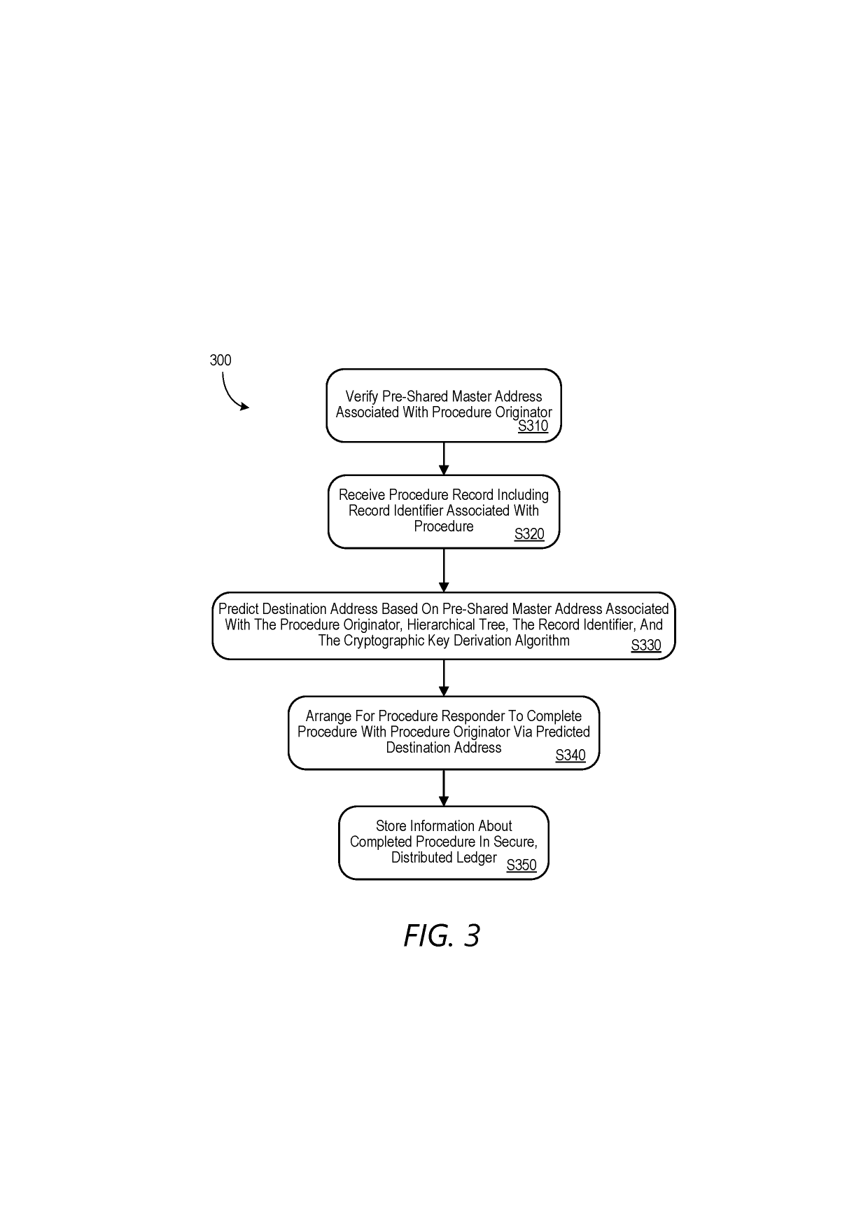

The elements of the system 200 may work together to perform the various embodiments of the present invention. Note that the system 200 of FIG. 2 is provided only as an example, and embodiments may be associated with additional or fewer elements or components. According to some embodiments, the elements of the system 200 automatically transmit information associated with an interactive user interface display over a distributed communication network. FIG. 3 is a procedure processing method 300 that might be performed, for example, by the system of FIG. 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a procedure responder may verify a pre-shared master address associated with a procedure originator. As used herein, the term “procedure” may refer to, for example, a transaction such as a payment. The procedure responder might comprise, for example, a procedure payer, a buyer entity, etc. The procedure originator might comprise, for example, a procedure payee, a seller entity, a supplier entity, etc. The pre-shared master address may comprise a root node of destination addresses in a hierarchical tree such that each child destination address of the hierarchical tree can be determined based on a parent destination address, a variable input (e.g., a payment reference), and a cryptographic key derivation algorithm. According to some embodiments, the cryptographic key derivation algorithm is a standard, multi-platform algorithm. In other embodiments, the cryptographic key derivation algorithm is a custom derivation function potentially associated with an enterprise. Moreover, the destination addresses can be associated with hierarchical deterministic wallets, such wallets are associated with a decentralized cryptocurrency, a central bank digital currency, a deposit token issued by a bank, a tokenized deposit issued by a bank, a stablecoin or e-money token under Markets in Crypto Assets Regulation (“MiCAR”), any other cryptographic asset carrying a monetary value, etc. In some embodiments, the cryptographic key derivation algorithm utilizes a purpose identifier, a currency identifier, an account identifier, a procedure identifier, a change identifier, and/or an address index.

At S320, the procedure responder receives, from the procedure originator, a procedure record including a record identifier associated with a procedure. The procedure record might be associated with, for example, a business process, a business document, an invoice, etc. At S330, the procedure responder may predict a destination address based on the pre-shared master address associated with the procedure originator, the hierarchical tree, the record identifier, and the cryptographic key derivation algorithm.

At S340, the system may arrange for the procedure responder to complete the procedure with the procedure originator via the predicted destination address. Information about the completed procedure is then stored in a secure, distributed ledger at S350. The completed procedure might be an invoice payment, a refund payment, a Human Resources (“HR”) payment, an investment payment, etc. The secure, distributed ledger might be associated with a blockchain, a tangle, a hashgraph, a peer-to-peer network, and/or any other kind of distributed ledger that utilizes consensus between nodes. In some embodiments, the procedure responder may implement a payment process including a supplier issued invoice inbox, an accounts payable accountant that authorizes invoice payment, a software payment processing system, etc. Moreover, the procedure responder may implement a master data governance process, such as one including supplier master data, account managers to verify and maintain root addresses, a business partner master data database, etc. Further, in some embodiments the procedure processing framework is implemented as part of software that processes procedures with digital currency to make and receive payments. Such software may be, for example, integrated with Enterprise Resource Planning (“ERP”), Human Resources (“HR”) or Supply Chain Financing (“SCF”) processes.

By utilizing hierarchical deterministic wallets at the invoice level, embodiments may enable a reconciliation of incoming payments with substantial certainty, even without any reference information being available on the distributed ledger. Each incoming payment arrives on a unique address exclusively created for one specific reconciliation purpose, such as an invoice. Subsequently, these incoming payments can be forwarded to a centrally designated wallet for accumulation purposes, preventing fragmentation of holdings across transient invoice specific one-time wallets.

Hierarchical deterministic wallets are derived from a single root address resulting in a hierarchical structure. The root address is used as the starting point to generate a theoretically unlimited number of subordinated wallets by applying a cryptographic algorithm referred to as key derivation. The hierarchical structure organizes these wallets into a tree, with each branch representing a specific purpose or level of derivation. By following a deterministic algorithm, such as the BIP32 standard, new wallets can be derived from a parent wallet in a predictable and repeatable manner. This methodology supports the creation of a hierarchical tree of any complexity, including legal entities and organizational structures, business partners, and business document number ranges. Key derivation is a fundamental aspect of many cryptographic systems and is used in various applications such as encryption, digital signatures, and digital currency wallets.

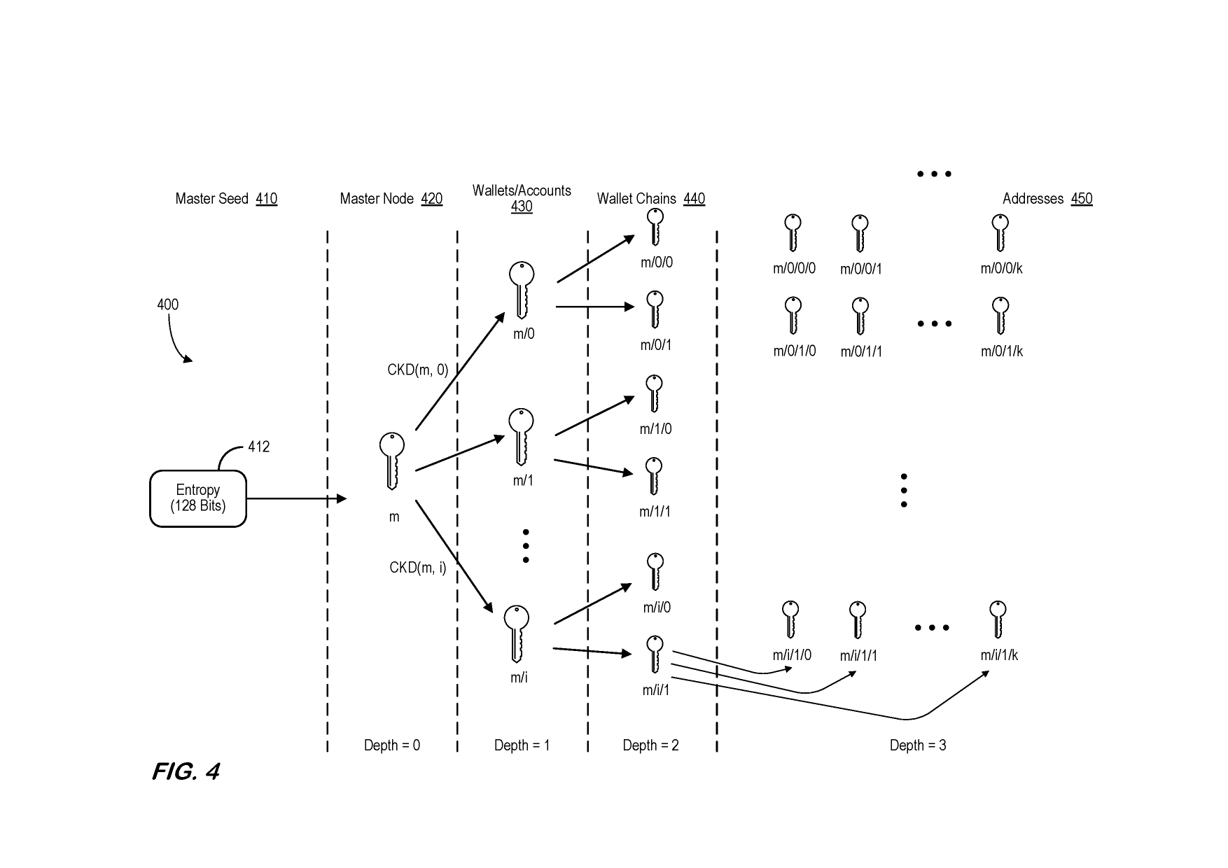

A deterministic approach may be helpful, even though reconciliation can technically be achieved with random wallets. FIG. 4 is a tree 400 of hierarchical wallets in accordance with some embodiments. The tree 400 begins with a master seed 410, such as 128-bit entropy 412. This is used to create a master node 420 (depth of 0) labeled “m.” A function CKD(m, i) can be used to create wallets or accounts 430 labeled m/0, m/1, … m/i (depth of 1) from the master node 420m. Wallet chains 440 (depth of 2) labeled m/0/0, m/0/1, … m/i/0, m/i/1… can then be used to create unique wallet addresses 450 (depth of 3) labeled m/0/0/0, m/0/0/1, … m/0/0/k, … m/i/1/k.

According to some embodiments, standard key derivation functions are used for extensive compatibility. Every individual standard defines a specific child ley derivation function and parameters that ensure deterministic results across all applications that adhere to it (regardless of the application or platform being used). For example, BIP32 is one of the most widely adopted standards and is primarily used in consumer wallets that support multiple blockchains and digital currencies. It defines a function that requires the following input arguments:

m' / purpose' / coin_type' / account' / change / address_index

The apostrophe (') indicates hardened derivation, ensuring that the account’s child keys are not publicly derivable and requires knowledge of the root key or seed to be computed. A tree 400 such as the one illustrated in FIG. 4 may be achieved. The input legend of the required input arguments:

m: The letter “m” represents the root (master) key or seed of the wallet.

purpose: The “purpose” is a constant value defined by the BIP44 specification, indicating the purpose of the key derivation. It typically has a value of 44' to indicate that the keys are being derived for use with BIP44-compatible wallets.

coin_type: The “coin_type” is a constant value representing the digital currency or blockchain being used. Each digital currency has a unique currency identifier assigned to it. For example, Bitcoin has a currency identifier of 0' while Ethereum has a currency identifier of 60'.

account: The “account” represents a specific account within the wallet. Accounts are typically used to organize funds for different purposes or entities.

change: The “change” flag is used to distinguish between receiving and change addresses within the same account. Change addresses are used to receive change from procedures, while receiving addresses are used to receive payments from others.

address_index: The “address_index” is a sequential index used to generate specific addresses within an account. Each index corresponds to a unique address in the wallet.

Established standards benefit from collective input, rigorous testing, and shared maintenance responsibilities, which can significantly reduce the individual efforts and costs on any single organization or developer. However, such a standard may or may not be sufficient for the intended reconciliation, as these standards may be tailored for common use cases.

When there are very specific structural or performance requirements, a custom key derivation function can be developed to meet basically any need. Custom functions provide tailored solutions that handle unique constraints in a highly effective way. However, developing and maintaining a custom function involves significant implementation and maintenance costs, including the initial design and development phase, ongoing updates, and potential troubleshooting or optimization efforts over time. These efforts and costs are typically borne by a community when using established standard functions.

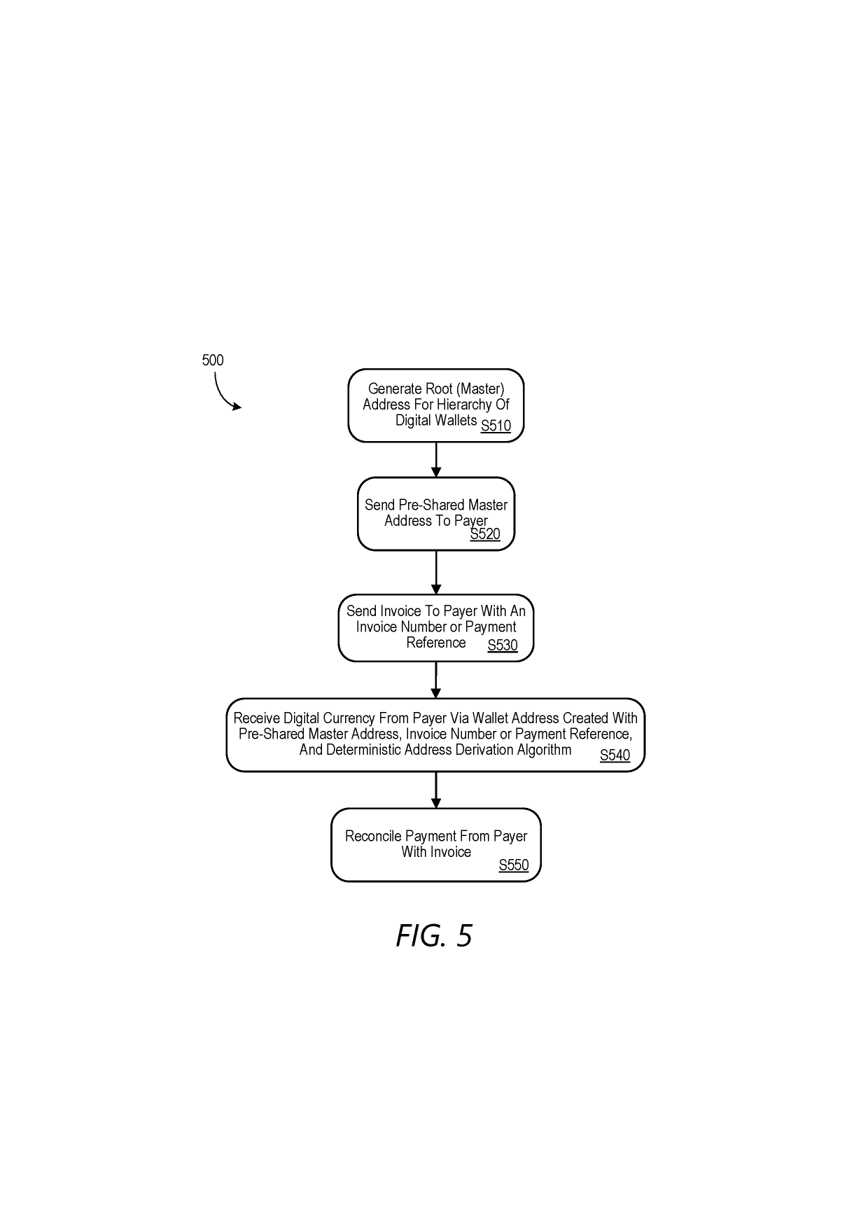

FIG. 5 is a procedure payee method 500 according to some embodiments. At S510, the payee generates a root (master) address for a hierarchy of destination wallets. At S520, the payee sends a pre-shared address to a payer. The payee may then send an invoice to the payer at S530. Subsequently, the payee received digital currency from the payer via a wallet address created with the pre-shared address, the invoice number or payment reference, and a deterministic address derivation algorithm at S540. The payment from the payer can then be reconciled with the invoice number or payment reference at S550 based on the wallet address.

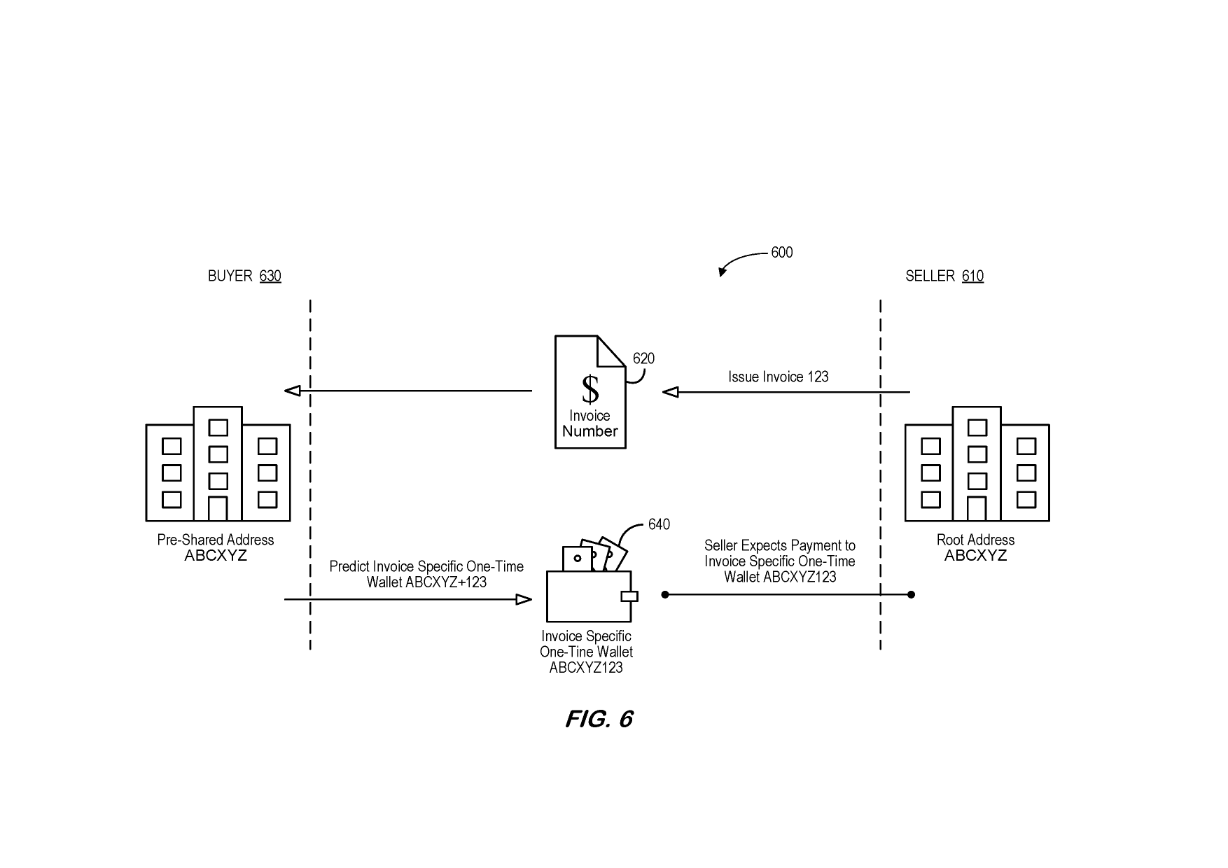

FIG. 6 is a procedure payee information flow 600 in accordance with some embodiments. The flow begins with a seller 610 transmitting an invoice 620 (having an invoice number or payment reference) to a buyer 630. The buyer 630 uses a previously received pre-shared address and the invoice number or payment reference to predict an invoice specific one-time wallet address. That address is used for the buyer 630 to provide payment 640 to the seller 610. Setting up a trustful reconciliation arrangement between business partners may begin with an agreement on a suitable distributed ledger network and digital currency. The business partners may also agree on a specific key derivation algorithm and a pre-shared piece of information (such as dedicated root address). These agreements let both the sender (buyer) and the receiver (seller) accurately predict the addresses involved in their processes. By using the same algorithm and pre-shared information, both parties can independently derive the same addresses, thereby ensuring trust and reliability. There is no need for the seller to message a pay-to destination address to the buyer (helping prevent address forgery).

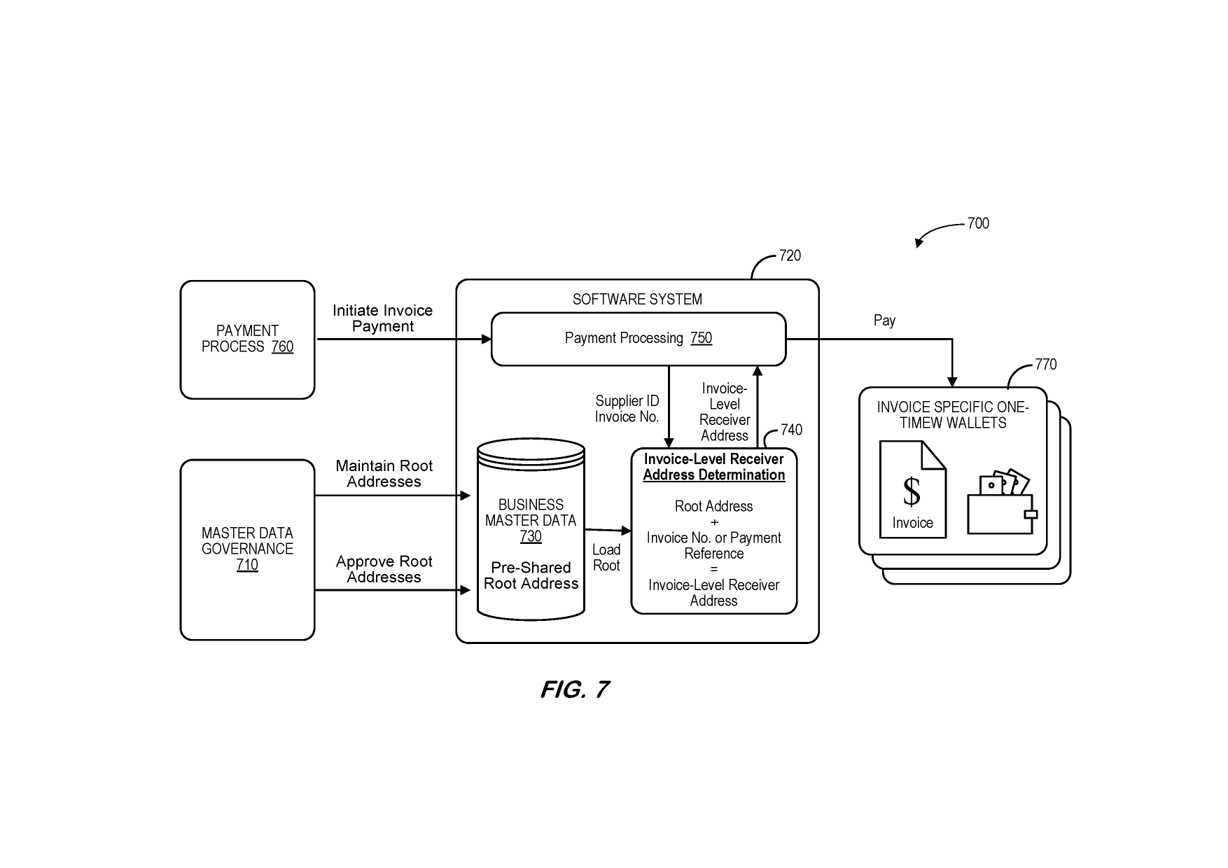

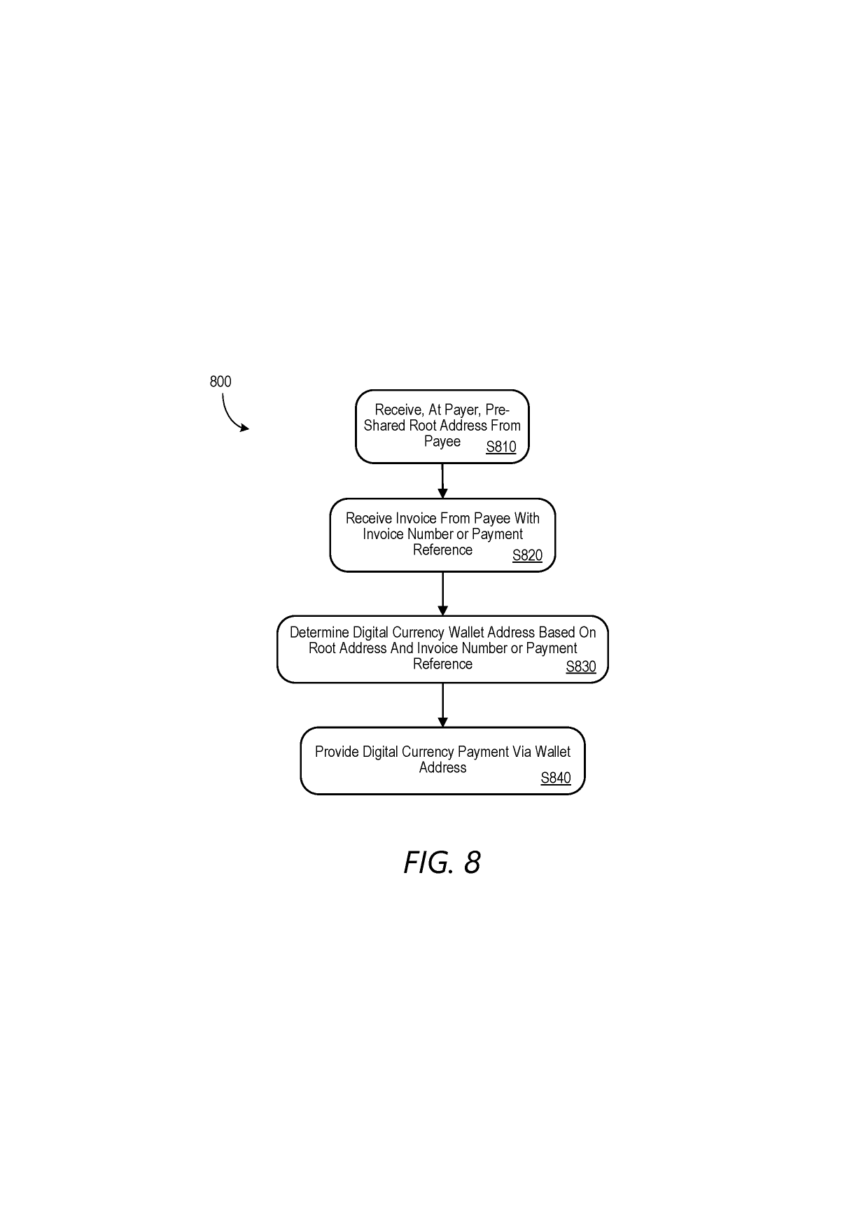

FIG. 7 is a procedure payer information flow 700 according to some embodiments. A master data governance 710 process may be applied by a payer to a software system 720 that includes payment processing 750. The master data governance 710 may help insured ensure the uniformity, accuracy, stewardship, semantic consistency, and accountability of the enterprise’s official shared master data assets, including maintaining and approving root addresses in business master data 730. A payment process 760 may initiate an invoice payment, causing the payment processing 750 to provide a supplier identifier and invoice number or payment reference to an invoice-level receiver address determination 740 process. The invoice-level receiver address determination 740 responds with an appropriate invoice-level receiver address that the payment processing 950 can use to provide payment via invoice specific one-time wallets 770. FIG. 8 is a procedure payer method 800 in accordance with some embodiments. At S810, a payer receives a pre-shared root address from a payee. At S820, the payer receives an invoice, with an invoice number or payment reference, from the payee. The payer can then determine a digital currency wallet address at S830 based on the root address and invoice number or payment reference. The payer provides a digital currency payment via that wallet address at S840.

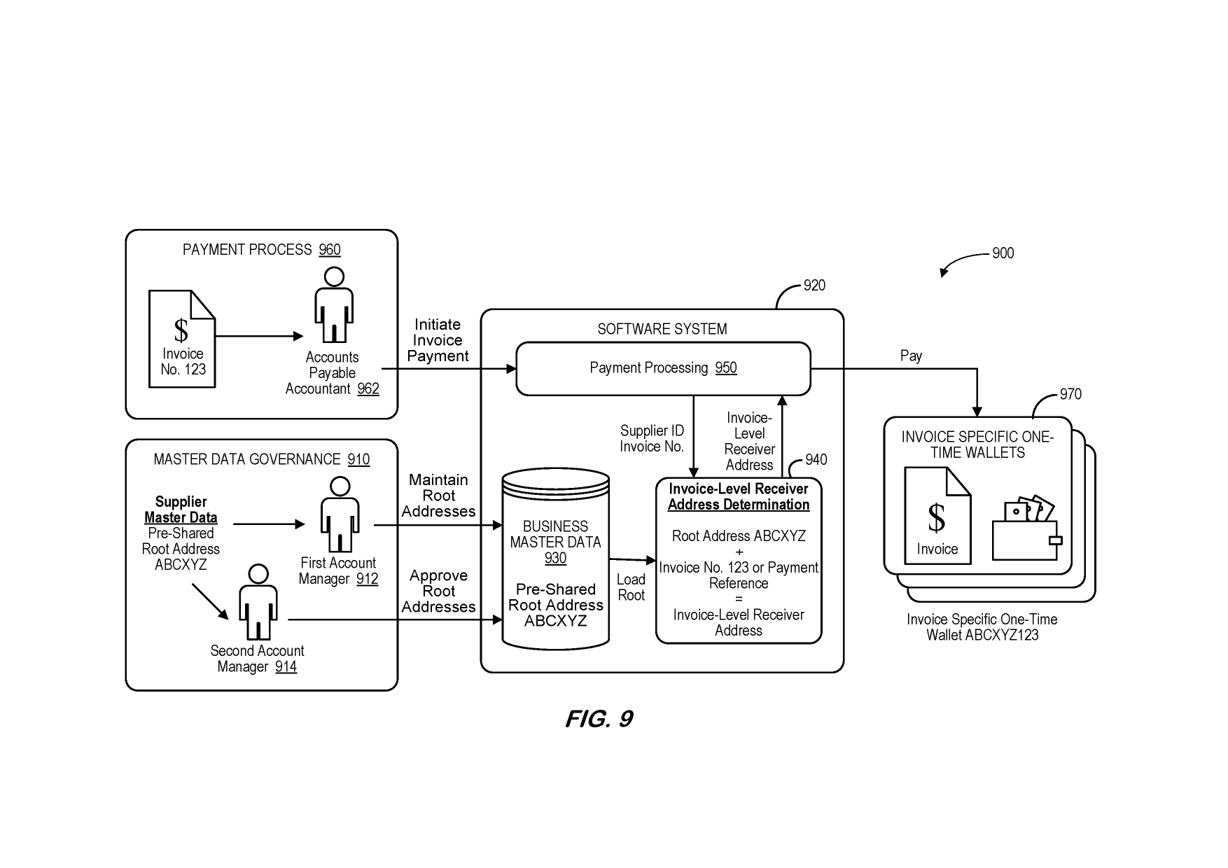

FIG. 9 is a more detailed procedure payer information flow 900 according to some embodiments. As before, a master data governance 910 process is applied by a payer to a software system 920 that includes payment processing 950. The master data governance 910 may include a first account manager 912 who maintains a root address in business master data 930. The master data governance 910 may also include a second account manager 914 who approves the root address in the business master data 930. A payment process 960 includes an accounts payable accountant 962 who initiates an invoice payment, causing the payment processing 950 to provide a supplier identifier and invoice number or payment reference to an invoice-level receiver address determination 940 process. The invoice-level receiver address determination 940 responds with an appropriate invoice-level receiver address (based on the root address and invoice number or payment reference) that the payment processing 950 uses to provide payment via invoice specific one-time wallets 970.

In this way, financial procedures and payments may be managed through multifaceted processes. One aspect of these processes may be the management and notification of bank account information. Large and medium-sized enterprises typically do not make payments to the bank account information provided on an invoice to prevent fraud and unauthorized payments. Instead, they rely on the bank account details maintained and approved in the business master data 930 for the respective business partner.

If random wallet addresses were used, which would technically suffice for reconciliation, the issuer would need to print these addresses on the invoice. The recipient would then have to trust these addresses without verification, posing a risk of becoming a victim to fraudulent payment requests. Additionally, the issuer risks that the recipient will reject the invoice if the address does not match the one in the master data (possibly from a recent payment).

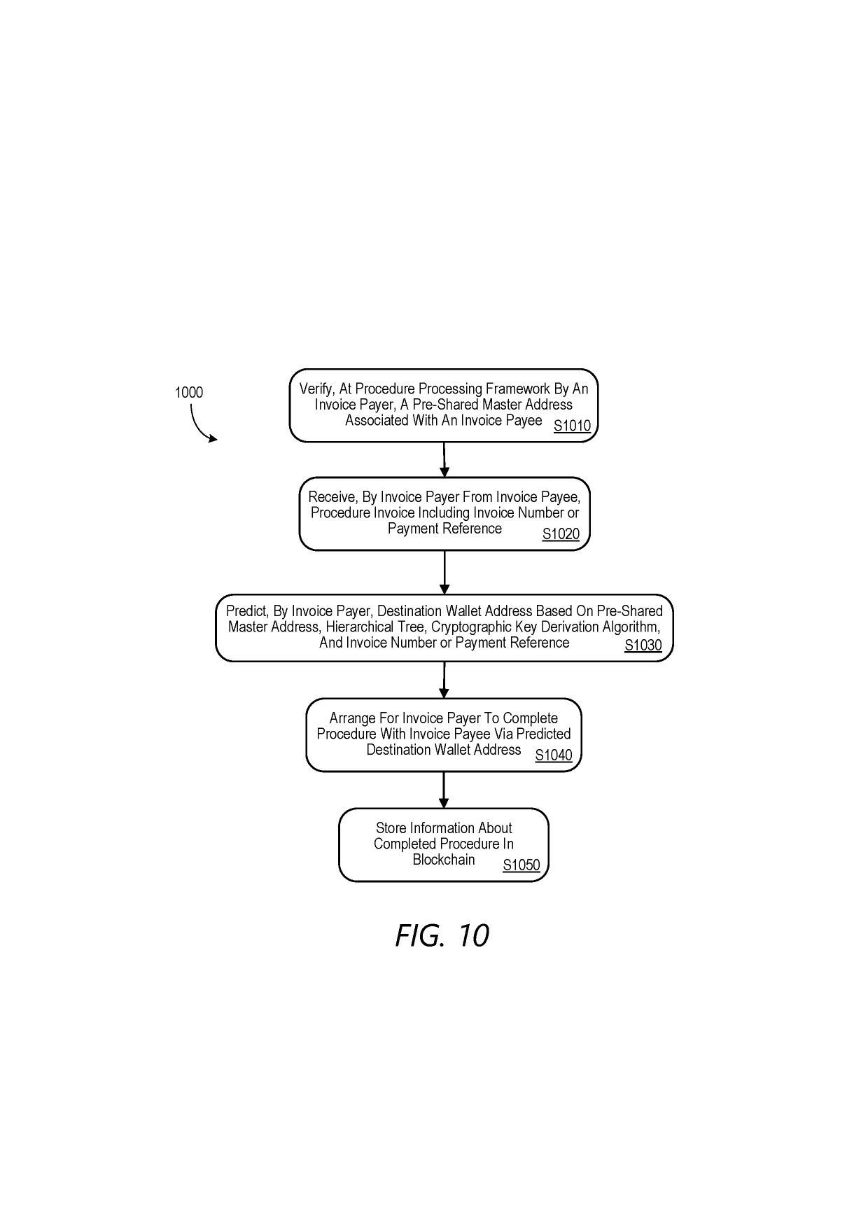

FIG. 10 is an invoice reconciliation method 1000 in accordance with some embodiments. At S1010, a procedure processing framework of an invoice payer may verify a pre-shared master address associated with an invoice payee. The invoice payer may then receive a procedure invoice (with an invoice number or payment reference) from the invoice payer at S1020. The invoice payer can then predict an appropriate invoice specific one-time destination wallet address at S1030 based on the pre-shared master address, a hierarchical tree of wallets, a cryptographic key derivation algorithm, and the invoice number or payment reference. At S1040, the system arranges for the invoice payer to complete the procedure with the procedure payee via the predicted destination wallet address. Information about the completed procedure is then stored in a secure, distributed ledger at S1050.

Without an alignment on a key derivation algorithm and a shared piece of information, such as a root address, there may be inconsistencies in the addresses generated by each party, leading to potential errors in procedures, loss of funds, and compromised security. Therefore, this alignment plays an important role in the infrastructure of the settlement and reconciliation system, ensuring that both parties can reconcile accurately in a predictable and repeatable manner. That alignment may or may not be orchestrated by the system that implements the payment reconciliation and address prediction processes.

Safeguards, such as the “Four-Eyes” principle and a separation of duties may be employed. As in any organizational or business setting, implementing robust procedures for managing master data is essential to ensure compliance with regulatory standards, particularly within financial or monetary contexts. Implementing the Four-Eyes principle for managing pre-shared information, such as root address, helps mitigate risks associated with errors, fraud, and unauthorized procedures. Moreover, a separation of duties between account managers responsible for maintaining master data and Accounts Receivable/Accounts Payable (“AR/AP”) accountants responsible for procedure execution to further enhance integrity and security.

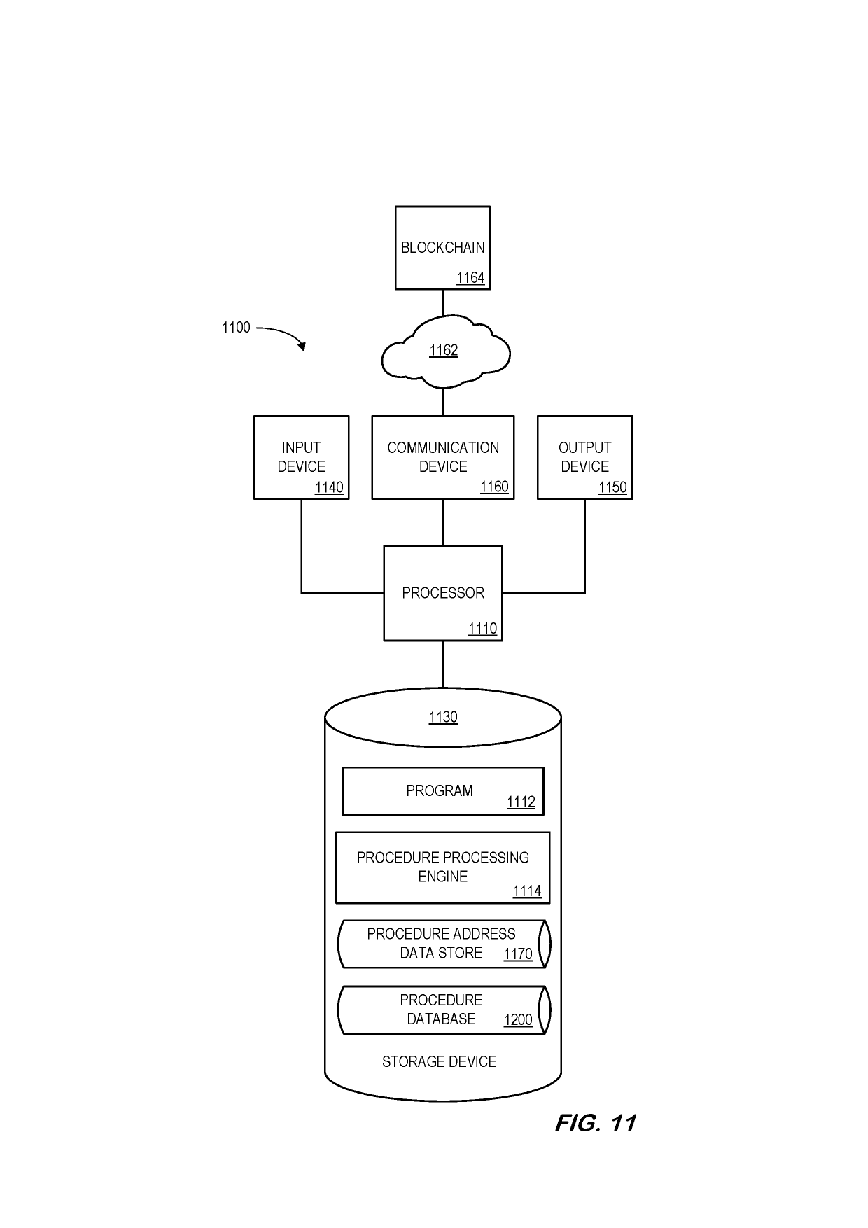

Note that the embodiments described herein may be implemented using any number of different hardware configurations. For example, FIG. 11 is a block diagram of an apparatus or platform 1100 that may be, for example, associated with the system 200 of FIG. 2 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162. The communication device 1160 may be used to communicate, for example, with one or more remote blockchain platforms 1164, payee or payor systems, administrator platforms, etc. The platform 1100 further includes an input device 1140 (e.g., a computer mouse and/or keyboard to input mappings and/or address or wallet information) and/or an output device 1150 (e.g., a computer monitor to render a display, transmit recommendations and alerts, and/or create reports about procedures, feedback to improve system performance, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or procedure processing engine 1114 for controlling the processor 1110. The processor 1110 performs instructions of the programs 1112, 1114, and thereby operates in accordance with any of the embodiments described herein. For example, the processor 1110 may verify a pre-shared master address associated with a procedure originator (and the pre-shared master address is a root node of destination addresses in a hierarchical tree such that each child destination address of the hierarchical tree can be determined based on a parent destination address, a variable input (such as a payment reference) and a cryptographic key derivation algorithm). A procedure responder may receive, from the processor 1110, a procedure record including a record identifier associated with a procedure. The procedure responder then predicts a destination address based on the pre-shared address associated with the procedure originator, the hierarchical tree, the record identifier, and the cryptographic key derivation algorithm. It is then arranged for the procedure responder to complete the procedure with the processor 1110 via the predicted destination address, and information about the procedure is stored in a secure, distributed ledger 1164.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

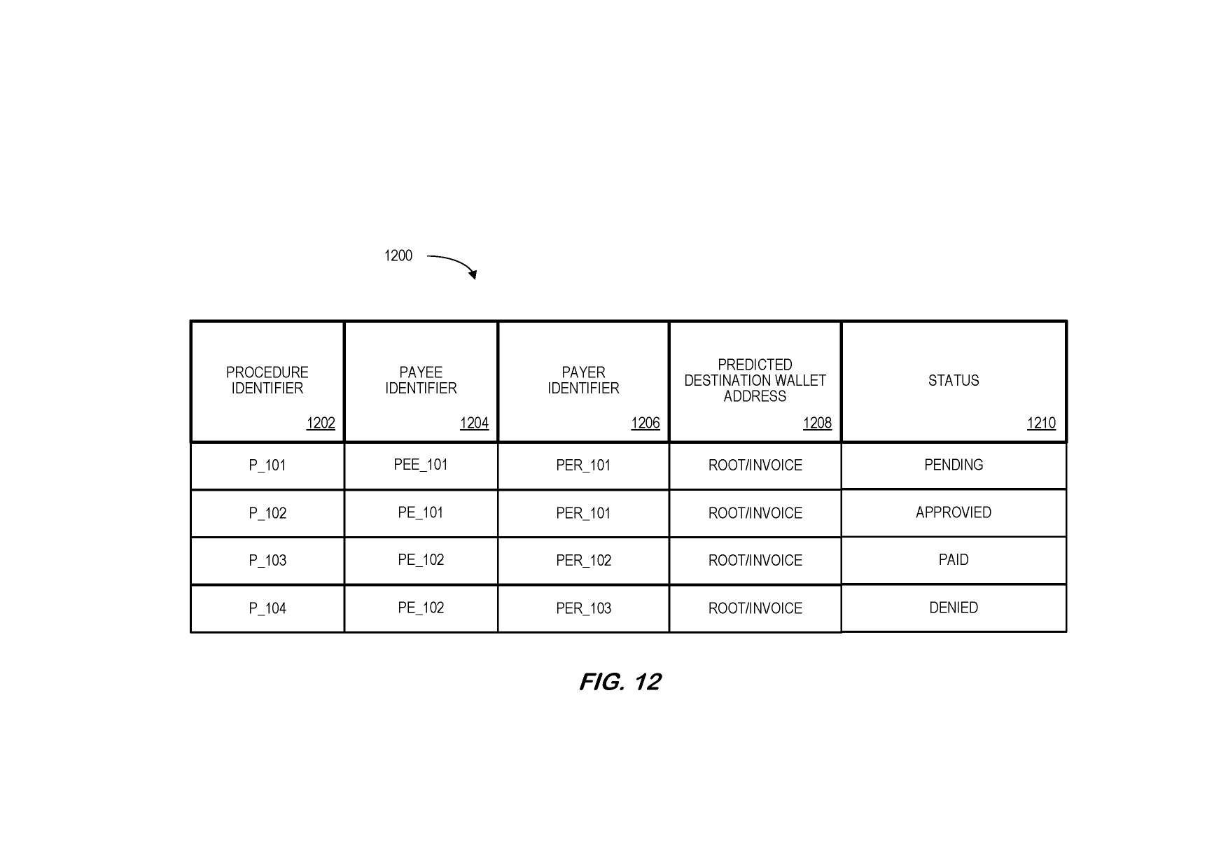

In some embodiments (such as the one shown in FIG. 11), the storage device 1130 further stores a procedure address data store 1170 and a procedure database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the procedure database 1200 that may be stored at the platform 1100 according to some embodiments. The table may include, for example, entries identifying ticket information associated with enterprise application incidents. The table may also define fields 1202, 1204, 1206, 1208, 1210 for each of the entries. The fields 1202, 1204, 1206, 1208, 1210 may, according to some embodiments, specify: a procedure identifier 1202, a payee identifier 1204, a payer identifier 1206, a predicted destination wallet address 1208, and a status 1210. The procedure database 1200 may be created and updated, for example, when a new procedure generated or received by the system, an existing procedure is updated, etc.

The procedure identifier 1202 might be a unique alphanumeric label that is associated with a particular payment procedure between a seller and buyer, a supplier and a customer, etc. The payee identifier 1204 may represent a seller or a supplier and the payer identifier 1206 may represent a buyer or customer. The predicted destination wallet address 1208 may be based on a pre-shared root address, an invoice number or payment reference, and a cryptographic key derivation algorithm. The status 1210 might indicate that the procedure is pending, approved, complete, denied, etc.

In this way, embodiments may utilize stable root addresses that can be shared and verified ahead of time. By using hierarchical deterministic wallets, embodiments may effectively mimic traditional fiat-based payment arrangements (which every company is familiar already with). During setup, the root address functions similarly to a main bank account, while the derived child addresses act like subaccounts within that main account. Sellers have the flexibility to use a single root address for all business partners or to assign individual root addresses for each business partner, based on their specific needs. These addresses can be shared with business partners ahead of time, enabling them to complete all master data-related due diligence processes, similar to how they would update bank account information today. Invoice-level receiver addresses can be anticipated by the payer. By using a deterministic approach in general, sellers have the option to provide individual receiver addresses on an invoice-level, depending on the payment arrangement with the buyer. However, buyers can still anticipate the invoice-level receiver addresses by using the pre-shared root address along with the invoice number or payment reference or a payment reference mentioned on the invoice. This ensures that even if specific addresses are not provided, buyers can reliably determine the correct invoice-level receiver address for each payment. Additionally, if the seller does provide an invoice-level receiver address, it can be verified using the same algorithm. Some embodiments might be implemented within software that processes procedures with digital currency to facilitate the reconciliation of incoming blockchain-based payments at the level of individual invoices. Examples of digital currencies include decentralized cryptocurrencies, central bank digital currencies, deposit tokens issued by a bank, tokenized deposits issued by a bank, stablecoins or e-money token under Markets in Crypto-assets Regulation (“MiCAR”), or any other cryptographic asset carrying a monetary value.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

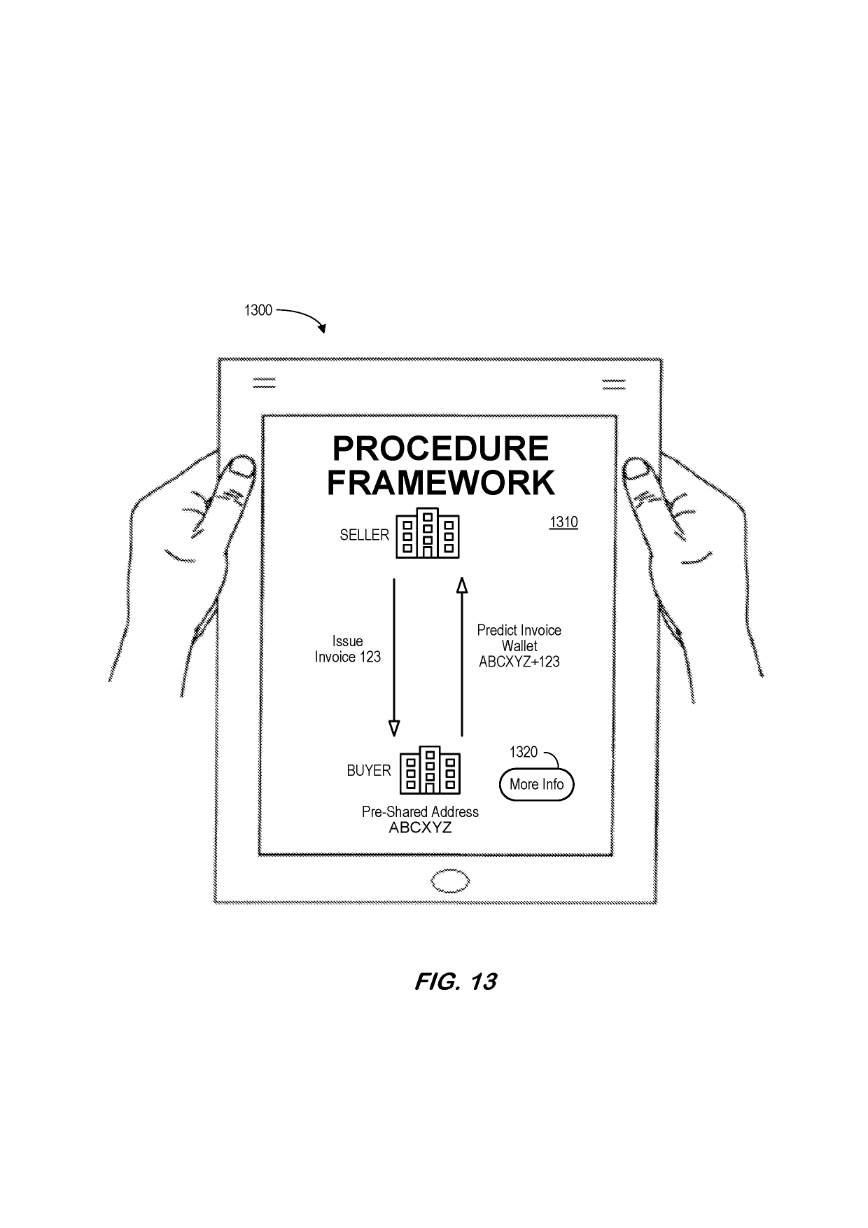

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of business procedures, any of the embodiments described herein could be applied to other types of business procedures. Moreover, the displays shown herein are provided only as examples, and any other type of user interface could be implemented. For example, FIG. 13 illustrates a tablet computer 1300 providing a procedure processing display 1310 including a buyer and seller. The display 1310 might be used, for example, to investigate aspects of a procedure payment via selection of a “More Info” icon 1320.

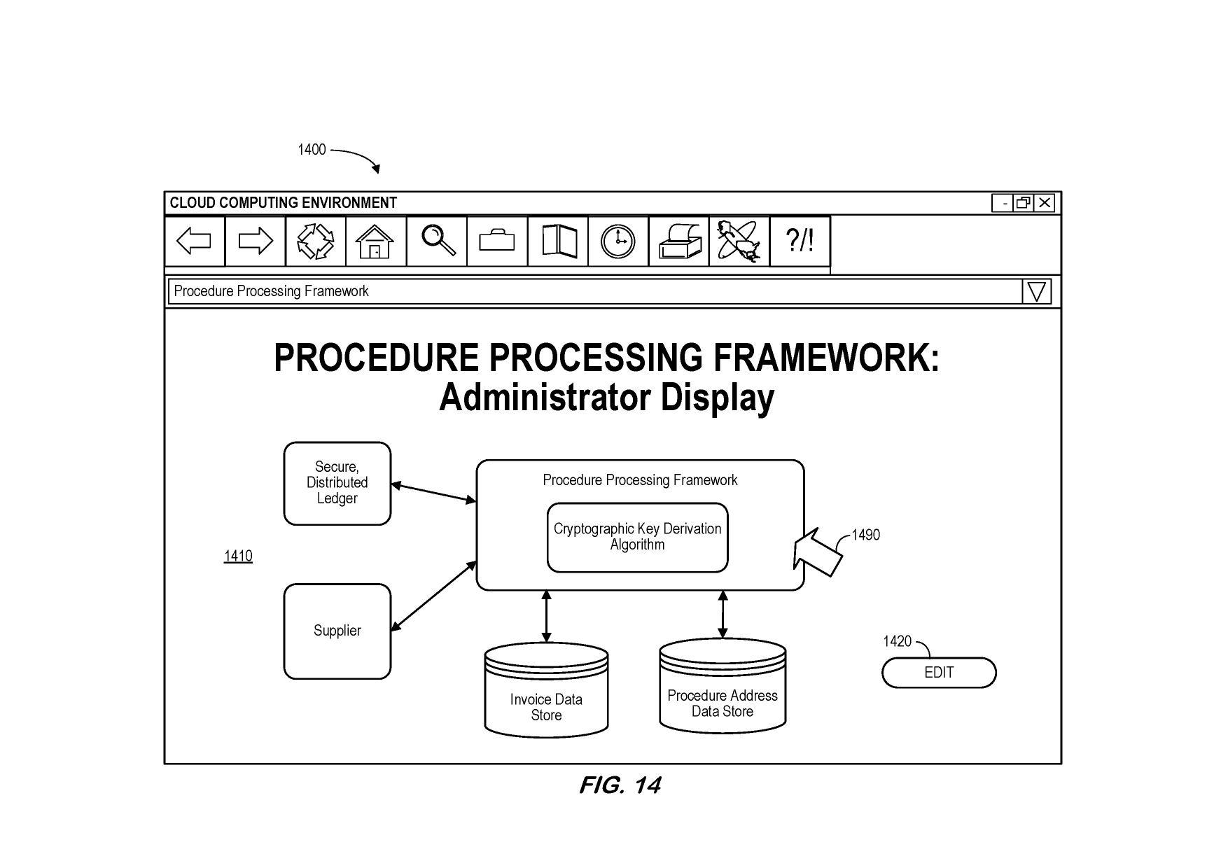

FIG. 14 is an operator or administrator display in accordance with some embodiments. The display 1400 includes a graphical representation 1410 of a procedure processing framework in accordance with any of the embodiments described herein. Selection of an element on the display 1400 (e.g., via a touchscreen or computer pointer 1490) may result in display of a pop-up window containing more detailed information about that element and/or various options (e.g., procedure details, invoice numbers or payment references, supplier communication addresses, etc.). Selection of an “Edit” icon 1420 may also let an operator or administrator adjust the operation of the system (e.g., to change system mappings, adjust procedure rules or logic, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with procedure processing, comprising:
a procedure and address data store containing electronic records, each procedure record being associated with a procedure originator and including a pre-shared master address for that procedure originator, and a procedure processing framework, coupled to the procedure and address data store, including:
a computer processor, and
a computer memory storing instructions that, when executed by the computer processor, cause the procedure processing framework to, for each of a plurality of procedures, the following steps:
verifying, by a procedure responder, a pre-shared master address associated with a procedure originator, wherein the pre-shared master address is a root node of destination addresses in a hierarchical tree of destination addresses such that each child destination address of the hierarchical tree can be determined based on a parent destination address, a record identifier, such as an invoice number or payment reference, and a cryptographic key derivation algorithm,
receiving, by the procedure responder from the procedure originator, a procedure record including a record identifier associated with a procedure,
predicting, by the procedure responder, a destination address based on the pre-shared master address associated with the procedure originator, the hierarchical tree, the record identifier, and the cryptographic key derivation algorithm,
arranging for the procedure responder to complete the procedure with the procedure originator via the predicted destination address, and
storing information about the completed procedure in a secure, distributed ledger.

2. The system of claim 1, wherein the cryptographic key derivation algorithm comprises a standard, multi-platform algorithm, optionally associated with a procedure originator.

3. The system of claim 1, wherein the cryptographic key derivation algorithm comprises a custom derivation function, optionally associated with a procedure originator.

4. The system of claim 1, wherein the cryptographic key derivation algorithm utilizes at least one of: (i) a purpose identifier, (ii) a currency identifier, (iii) an account identifier, (iv) a procedure identifier, (v) a change identifier, and (vi) an address index.

5. The system of claim 1, wherein the completed procedure recorded in the secure, distributed ledger is associated with at least one of: (i) a blockchain, (ii) a tangle, (iii) a hashgraph, (iv) a peer-to-peer network, and (v) any other kind of distributed ledger that utilizes consensus between nodes.

6. The system of claim 1, wherein the procedure responder implements a master data governance process including at least one of: (i) supplier master data, (ii) account managers to verify and maintain root addresses, and (iii) a business partner master data database.

7. The system of claim 1, wherein the procedure processing framework is implemented as part of software that processes procedures with digital currency.

8. A computer-implemented method associated with procedure processing, comprising:
verifying, at a computer processor of a procedure processing framework by a procedure responder, a pre-shared master address associated with a procedure originator, wherein the pre-shared master address is a root node of destination addresses in a hierarchical tree such that each child destination address of the hierarchical tree can be determined based on a parent destination address, a variable input such as a payment reference, and a cryptographic key derivation algorithm;
receiving, by the procedure responder from the procedure originator, a procedure record including a record identifier associated with a procedure;
predicting, by the procedure responder, a destination address based on the pre-shared master address associated with the procedure originator, the hierarchical tree, the record identifier, and the cryptographic key derivation algorithm;
arranging for the procedure responder to complete the procedure with the procedure originator via the predicted destination address; and
storing information about the completed procedure in a secure, distributed ledger.

9. The method of claim 8, wherein the cryptographic key derivation algorithm comprises a standard, multi-platform algorithm.

10. The method of claim 8, wherein the cryptographic key derivation algorithm comprises a custom derivation function potentially associated with an enterprise.

11. The method of claim 8, wherein the cryptographic key derivation algorithm utilizes at least one of: (i) a purpose identifier, (ii) a currency identifier, (iii) an account identifier, (iv) a procedure identifier, (v) a change identifier, and (vi) an address index.

12. The method of claim 8, wherein the completed procedure recorded in the secure, distributed ledger is associated with at least one of: (i) a blockchain, (ii) a tangle, (iii) a hashgraph, (iv) a peer-to-peer network, and (v) any other kind of distributed ledger that utilizes consensus between nodes.

13. The method of claim 8, wherein the procedure responder implements a master data governance process including at least one of: (i) supplier master data, (ii) account managers to verify and maintain root addresses, and (iii) a business partner master data database.

14. The method of claim 8, wherein the procedure processing framework is implemented as part of software that processes procedures with digital currency.

15. One or more non-transitory computer-readable media storing computer-executable instructions that, when executed by a computing system, cause the computing system to perform operations comprising:
verifying, at a computer processor of a procedure processing framework by a procedure responder, a pre-shared master address associated with a procedure originator, wherein the pre-shared master address is a root node of destination addresses in a hierarchical tree such that each child destination address of the hierarchical tree can be determined based on a parent destination address, a variable input such as a payment reference, and a cryptographic key derivation algorithm;
receiving, by the procedure responder from the procedure originator, a procedure record including a record identifier associated with a procedure;
predicting, by the procedure responder, a destination address based on the pre-shared master address associated with the procedure originator, the hierarchical tree, the record identifier, and the cryptographic key derivation algorithm;
arranging for the procedure responder to complete the procedure with the procedure originator via the predicted destination address; and
storing information about the completed procedure in a secure, distributed ledger.

16. The media of claim 15, wherein the cryptographic key derivation algorithm comprises a standard, multi-platform algorithm, optionally associated with a procedure originator.

17. The media of claim 15, wherein the cryptographic key derivation algorithm comprises a custom derivation function, optionally associated with a procedure originator.

18. The media of claim 15, wherein the cryptographic key derivation algorithm utilizes at least one of: (i) a purpose identifier, (ii) a currency identifier, (iii) an account identifier, (iv) a procedure identifier, (v) a change identifier, and (vi) an address index.

19. The media of claim 15, wherein the completed procedure recorded in the secure, distributed ledger is associated with at least one of: (i) a blockchain, (ii) a tangle, (iii) a hashgraph, (iv) a peer-to-peer network, and (v) any other kind of distributed ledger that utilizes consensus between nodes.

20. The media of claim 15, wherein the procedure responder implements a master data governance process including at least one of: (i) supplier master data, (ii) account managers to verify and maintain root addresses, and (iii) a master data database.
